(19) United States
(12) Patent Application Publication
(10) Pub. No.: US 2017/0369018 A1
(43) Pub. Date: Dec. 28, 2017

(54) SEAT OCCUPANCY SENSOR UNIT, AND SEAT

(71) Applicant: IEE INTERNATIONAL ELECTRONICS & ENGINEERING S.A., Echternach (LU)

(72) Inventors: Gorden HÜTHER, Wadgassen (DE); Dietmar JUNGEN, Mehren (DE); Jörg BECK, Bernkastel-Kues (DE)

(21) Appl. No.: 15/538,044

(22) PCT Filed: Dec. 22, 2015
(86) PCT No.: PCT/EP2015/081027

§ 371 Date: Jun. 20, 2017

(30) Foreign Application Priority Data
Dec. 23, 2014 (DE) 20 2014 010 081.0
Feb. 9, 2015 (LU) 92 651

(51) Int. Cl. B60R 21/015; B60N 2/00; B60N 2/70

(52) U.S. Cl. CPC B60R 21/01524; B60N 2/002; B60N 2/7094

(57) ABSTRACT

A seat occupancy sensor unit for recognizing occupancy of a vehicle seat. The sensor unit includes a mounting plate, a membrane switch which responds to pressure, and at least one support element which is arranged between the top of the mounting plate and the membrane switch. The at least one support element has a developable, convexly curved surface, which is provided for the purpose, in at least one operating state, of coming into at least partial contact with the membrane switch at least at the location of the at least one active switching element. A vehicle seat is provided, which comprises a seat base for supporting a person in a sitting position, a seat cushion with a foam element for padding the seat base, and a seat occupancy sensor unit. The foam element includes on the bottom thereof a recess for accommodating the seat occupancy sensor unit.

### TECHNICAL FIELD

The present invention relates to a seat occupancy sensor unit for recognizing occupancy of a seat, in particular of a vehicle seat, and to a seat having such a seat occupancy sensor unit.

### BACKGROUND OF THE INVENTION

Vehicle seat occupancy sensors and systems for vehicle seat occupancy recognition are these days frequently used in vehicles, in particular in cars, in order to provide an electrical signal which corresponds to seat occupancy for various applications. Merely by way of example, such applications include seat belt monitoring (seat belt reminder (SBR)) and monitoring the activation of an airbag system (auxiliary restraint system (ARS)).

Vehicle seat occupancy sensors of the most varied kinds are used for this purpose. Vehicle seat occupancy sensors may inter alia take the form of capacitive sensors, deformation sensors or pressure- or force-sensitive sensors.

For example, international application WO 2014/075953 A1 describes a unit provided on the B side of a foam pad of a vehicle seat for vehicle seat occupancy recognition, which unit comprises a mounting plate with an upwardly directed surface and a downwardly directed surface and a plurality of lateral support elements for supporting the mounting plate on a seat suspension by which an upper surface of the unit is defined. The upwardly directed surface of the mounting plate is arranged in recessed manner relative to the upper surface of the unit. A first foam cushion is provided between the support elements and rests on the mounting plate. A recess provided in the upwardly directed surface of the mounting plate beneath the first foam cushion serves to accommodate a second foam cushion which bears a pressure- or force-sensitive sensor which takes the form of a membrane switch. The recess has a depth which is greater than a sum of a height of the membrane switch and a height of the second foam cushion. The membrane switch projects laterally beyond a first edge of the second foam cushion and an opposing second edge thereof.

### SUMMARY

The invention relates to a seat occupancy sensor unit for recognizing occupancy of a seat, in particular of a vehicle seat, comprising
a mounting plate with a bottom and a top, the bottom facing, in an operational state, a floor on which the seat is fitted, and the top facing a seat cushion of the seat,
a membrane switch which responds to pressure having at least one active switching element, the switching state of which is modifiable when a threshold value for a force acting in a direction perpendicular to the at least one active switching element is exceeded, and
at least one support element which is arranged between the top of the mounting plate and the membrane switch.

A “vehicle” should in this connection in particular, but not exclusively, be taken to mean cars, trucks and buses.

It is proposed that the at least one support element have a developable, convexly curved surface, the dimensions of which are greater than or equal to the dimensions, measured in the same direction, of the membrane switch, and which is provided for the purpose, in at least one operating state, of coming into at least partial contact with the membrane switch at least at the location of the least one active switching element.

A “developable surface” should in this connection in particular be taken to mean a surface which can be transformed into the Euclidean plane without distortion. The Gaussian curvature is equal to zero at every point of a developable surface. The most important examples of developable surfaces are the cylinder envelope and cone envelope.

In this manner, it is possible to achieve increased sensitivity of the membrane switch to forces acting obliquely on a seat cushion of the seat. In addition, it is possible to dispense with a foam cushion as known from the prior art arranged beneath the membrane switch.

It is furthermore proposed that the membrane switch which responds to pressure comprise at least one first flexible, electrically insulating carrier membrane and one second flexible, electrically insulating carrier membrane and at least one first electrically conductive electrode and one second electrically conductive electrode.

The first flexible, electrically insulating carrier membrane and the second flexible, electrically insulating carrier membrane are arranged spaced apart from one another substantially parallel to one another and are separated from one another by an electrically insulating spacer membrane. In an unoccupied seat state, the spaced carrier membranes are arranged substantially parallel to the mounting plate.

The first electrically conductive electrode is arranged on the first carrier membrane and the second electrically conductive electrode is arranged on the second carrier membrane. The spacer membrane comprises at least one continuous recess, and the first electrically conductive electrode, the second electrically conductive electrode and the continuous recess at least partially overlap one another in the direction perpendicular to the carrier membranes to form the at least one active switching element.

As a consequence, the seat occupancy sensor unit may be provided in a structurally simple manner with a durable membrane switch which, on exposure to a force onto a seat cushion of the seat, reliably comes into at least partial contact with the at least one support element.

In a preferred development of the seat occupancy sensor unit, a change in the dimension of the support element in the direction perpendicular to the at least one active switching element amounts to less than 10% of a change in the dimension of the membrane switch in the same direction on exposure to a force corresponding to the threshold value. As a consequence, it is possible to achieve a well defined and reproducible threshold value for a modification in the switching state of the at least one active switching element.

It is furthermore proposed that the convexly curved surface of the support element take the form of part of a circumferential surface of a right cylinder with an elliptical base area. In this manner, a support element can be provided which has advantageously extensive design freedom for design of the support element.

In a preferred development of the seat occupancy sensor unit, an aspect ratio of the convexly curved surface of the support element amounts to at least 3:1. The side lengths of the convexly curved surface should here be taken to mean the dimensions of the surface in a parallel projection onto the mounting plate. Thanks to the aspect ratio of at least 3:1, it is possible to provide advantageously extensive latitude for the design of the membrane switch.

In one particularly preferred development, the convexly curved surface of the support element takes the form of part of a circumferential surface of a right cylinder with a circular base area, wherein the diameter thereof amounts to between 20 mm and 100 mm and the support element has a height measured from the top of the mounting plate of up to 10 mm. In this manner, it is possible combine compactness of the seat occupancy sensor unit with a membrane switch which functions effectively.

The seat occupancy sensor unit may be produced simply and inexpensively if the support element and the mounting plate are of one-piece construction. In this connection, “one-piece” should in particular be taken to mean materially bonded, such as for example by a welding process and/or an adhesive bonding process, and, particularly advantageously, molded on, as in the case of production from a casting and/or of production using a single or multiple component injection method. In particular, the mounting plate with the support element may particularly advantageously be produced from a thermoplastic in an injection molding method.

In a further advantageous development of the seat occupancy sensor unit, the membrane switch comprises a plurality of active switching elements which are spaced apart from one another and, in an operational state, are arranged in a seating direction of the seat. A “seating direction” of the seat should in this connection in particular be taken to mean a direction which, in the case of a person occupying the seat, extends from said person's hip joint through the person's knee joint on the same side.

As a consequence, it is possible to provide a membrane switch which responds to pressure, in which the switching state of the active switching element or the switching states of the active switching elements in question is/are modifiable when a threshold value for a force acting in a direction perpendicular to one or more than one of the active switching elements is exceeded. The switching states of the active switching elements may advantageously be logically linked to one another for recognizing occupancy of a seat. As a consequence, it is for example also possible reliably to recognize seat occupancy at a front-most edge of the seat cushion in the seating direction.

In a further preferred development, the seat occupancy sensor unit comprises a release membrane element which, in the operational state, is arranged above the membrane switch. In this way, it is advantageously possible for the membrane switch to be effectively prevented from adhering to the seat foam during use of the seat occupancy sensor unit in a seat and, hence, to prevent potential malfunction of the seat occupancy sensor unit.

In a preferred development, the release membrane element has, at least on a side facing the membrane switch or a side facing the seat foam, a coating with a chemical release agent. Both sides of the release film element may also be coated with the chemical release agent. The chemical release agent may for example be formed by a release agent based on PTFE (polytetrafluoroethylene). Alternatively, other release agents which appear suitable to a person skilled in the art may also be used.

In a further preferred development, the first electrode and the second electrode of the membrane switch are produced by thick-film technology. In this manner, it is possible to achieve a high level of precision and reproducibility with regard to a modification in the switching state of the at least one active switching element due to a threshold value for a force acting in the direction perpendicular to the at least one active switching element being exceeded.

In a further preferred development, at least one of the flexible, electrically insulating carrier membranes at least predominantly consists of a thermoplastic. As a consequence, it is possible to achieve high dimensional accuracy of the flexible, electrically insulating carrier membrane and, as a result of the high dimensional accuracy, a high level of accuracy and reproducibility with regard to a modification in the switching state of the at least one active switching element due to a threshold value for a force acting in the direction perpendicular to the at least one active switching element being exceeded. In addition, it is possible to provide a membrane switch which has a tensile strength in directions parallel to the insulating carrier membranes which withstands mechanical loading when the membrane switch comes into contact with the support element.

The thermoplastic is preferably selected from a group which is made up of polyethylene terephthalate (PET), polyethylene naphthalate (PEN), polyimides (PI), polyetherether ketone (PEEK), polyether sulfone (PES), polyphenylene sulfide (PPS), polysulfone (PSU) and a blend of at least two of these plastics.

A seat, in particular a vehicle seat, is furthermore proposed which comprises a seat base for supporting a person in a sitting position and a seat cushion with at least one foam element for padding the seat base, wherein the at least one foam element has a top which faces the person in the sitting position and a bottom which faces the seat base and is also designated the B side of the foam element. The seat furthermore includes a development of a seat occupancy sensor unit such as described above. The at least one foam element includes on the bottom thereof a recess for accommodating the seat occupancy sensor unit.

The term “seat base” is intended in this connection in particular to comprise a spring suspension or a seat shell for supporting the at least one foam element.

In one advantageous development, in the direction perpendicular to the mounting plate the recess takes the form of a first step and a second step. The first step is provided for accommodating a peripheral zone of the mounting plate. The second step serves to accommodate the remaining parts of the seat occupancy sensor unit, wherein, in the direction perpendicular to the mounting plate, a dimension of the recess in an unoccupied state of the seat is greater than a dimension of the seat occupancy sensor unit in said direction. In particular, in the direction perpendicular to the mounting plate, a dimension of the second step is intended to be greater than a dimension of the seat occupancy sensor unit in said direction, measured from the top of the mounting plate. As a consequence, the seat occupancy sensor unit can be securely mounted, wherein, when the seat is unoccupied, it is simultaneously possible to avoid mechanically loading the membrane switch by the at least one foam element.

If, viewed in the seating direction, the membrane switch of the seat occupancy sensor unit is arranged between the H point and a front edge of the seat or directly in front of the H point, occupancy of the seat may also be reliably and unquestionably established if the person occupying the seat has adopted a casual sitting position which differs from a standard sitting position and in which a major part of the weight force is absorbed by the front edge of the seat. The H point is a seat reference point. In vehicle seats, the H point is the point of the theoretical axis of rotation between the leg and the torso of a human body represented by a manikin, in a vertical, longitudinal plane of the seat. The H point and methods for determining it are described in relevant standards such as DIN 70020-1:1993-02 or SAE J1100.

It is additionally proposed that the seat occupancy sensor unit have at least one first fastening element and the foam element have at least one second fastening element arranged on the bottom thereof, wherein the first fastening element and the second fastening element can be brought into mutual engagement to produce a firm, undoable connection. In this manner, the seat occupancy sensor unit can reliably be arranged in a desired position relative to the foam element. As a consequence, it is ensured that the force exerted by occupancy of the seat acts reproducibly on the membrane switch.

### BRIEF DESCRIPTION OF THE DRAWINGS

Further advantages are revealed by the following description of the drawings. The drawings show an exemplary embodiment of the invention. The drawings, description and claims contain numerous features in combination. A person skilled in the art will expediently also consider the features individually and combine them into meaningful further combinations. In the figures:

FIG. 1 shows a schematic, sectional partial view of a vehicle seat according to an embodiment of the invention in an unoccupied state,

FIG. 2 shows a schematic view of the vehicle seat of FIG. 1 in an occupied state,

FIG. 3 shows a perspective, schematic view of an embodiment of a seat occupancy sensor unit according to the invention, and

FIG. 4 shows a schematic diagram of the ratios of forces when the membrane switch of the seat occupancy sensor unit according to FIG. 3 is exposed to a force.

### DETAILED DESCRIPTION

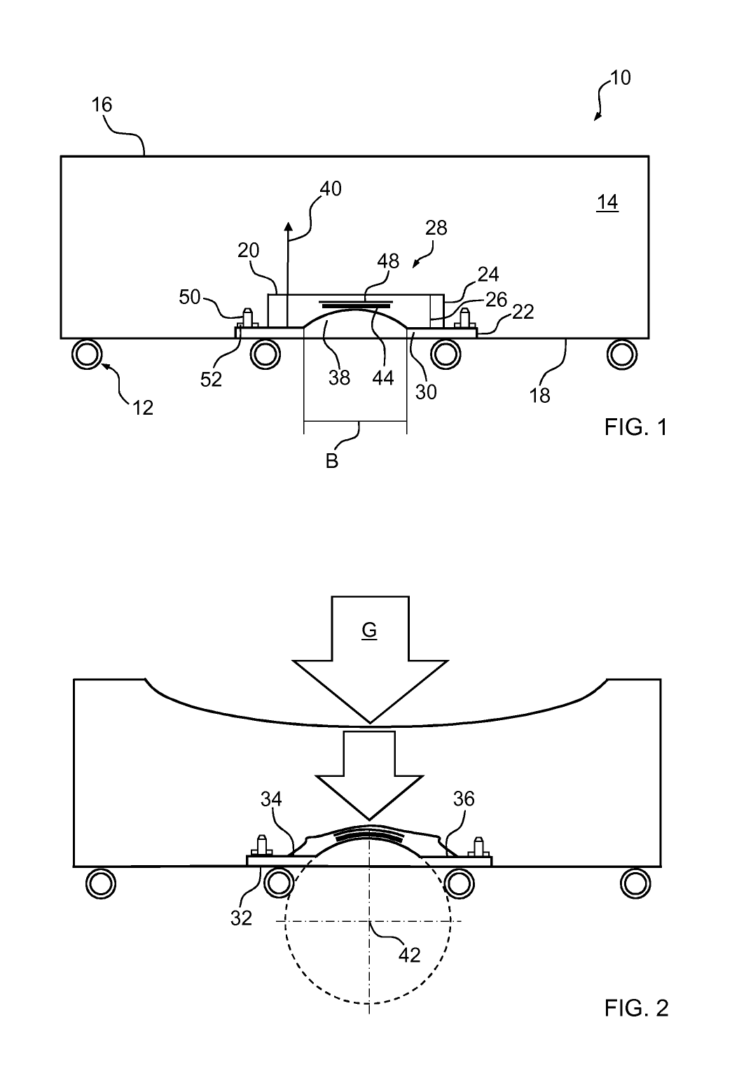

FIG. 1 shows a schematic, sectional partial view, in a plane perpendicular to a direction of travel of the car, of a seat 10, in particular a vehicle seat, according to the invention fitted in a car and in an unoccupied state.

The vehicle seat comprises a seat base in the form of a spring suspension 12 for supporting a person in a sitting position and a seat cushion with a cushion cover (not shown) and a foam element 14 for padding the seat base. The foam element 14 has a top 16, which faces a seated person, and a bottom 18 (B side) which faces the seat base. The section plane of the view shown in FIG. 1 extends through the middle of the foam element 14.

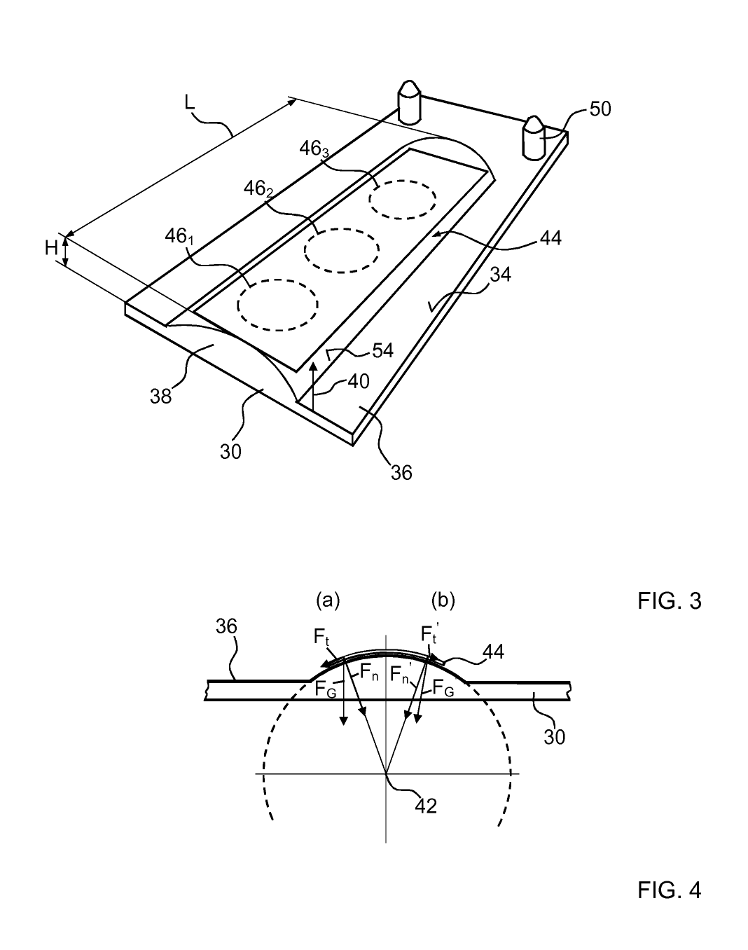

The vehicle seat furthermore includes a seat occupancy sensor unit 28 for recognizing occupancy of the vehicle seat. A recess 20 is formed centrally on the B side of the foam element 14, said recess serving to accommodate the seat occupancy sensor unit 28. The reference signs for the seat occupancy sensor unit 28 are to be found in FIGS. 1 to 3.

The seat occupancy sensor unit 28 comprises a mounting plate 30 made from a thermoplastic with a bottom 32 and a top 34, wherein, in an operational installed state, the bottom 32 faces the floor of the car, on which the vehicle seat is fitted, and the top 34 faces the seat cushion.

The terms “on top”, “over” and “above” and “below”, “beneath” and “under” used in the present description should be understood in relation to a direction 40 perpendicular to the mounting plate 30, wherein “on top”, “over” and “above” are intended to mean arranged further away from the mounting plate 30 and/or facing the seated person, while “below”, “beneath” and “under” are intended to mean arranged closer to the mounting plate 30 and/or facing the car floor.

The seat occupancy sensor unit 28 furthermore includes a membrane switch 44 which responds to pressure and a support element 38 which, in relation to the direction 40 perpendicular to the mounting plate 30, is arranged between the top 34 of the mounting plate 30 and the membrane switch 44.

The support element 38 is formed on the top 34 of the mounting plate 30 from the same thermoplastic and molded in one piece on the mounting plate 30 by means of an injection molding method. The support element 38 is in the form of a circumferential surface of a right cylinder with a circular base area with a diameter of 60 mm, wherein an axis of symmetry 42 of the right cylinder is arranged parallel to the mounting plate 30 and in the seating direction, and breaks through the top 34 of the mounting plate 30 to a height of 3.5 mm and over a width of 30 mm.

The support element 38 thus has a developable, convexly curved surface 54.

Dimensions L and B of the support element 38 are greater than the dimensions of the membrane switch 44 measured in the same direction. An aspect ratio of the convexly curved surface 54 of the support element 38 amounts to approx. 8:1. As is explained below, in at least one operating state, the support element 38 is intended to come into mechanical contact with the membrane switch 44.

The membrane switch 44 comprises a first flexible, electrically insulating carrier membrane and a second flexible, electrically insulating carrier membrane, both of which entirely consist of polyethylene terephthalate and are rectangular in shape, wherein, in an operational installed state, the longer axis of symmetry of the rectangular shape is arranged parallel to an axis of symmetry 42 of the support element 38. The first flexible, electrically insulating carrier membrane and the second flexible, electrically insulating carrier membrane are arranged spaced apart from one another and parallel to one another and are separated from one another by an electrically insulating spacer membrane. In the unloaded operational state, the spaced carrier membranes are oriented parallel to the mounting plate 38.

The membrane switch 44 furthermore contains three electrically conductive first electrodes arranged spaced apart on the first carrier membrane and three electrically conductive second electrodes arranged spaced apart on the second carrier membrane (not shown). The first and the second electrodes are produced by thick-film technology from an electrically conductive paste. In relation to the direction 40 perpendicular to the mounting plate 38, each of the three first electrodes is arranged to overlap in centered manner with one of the three second electrodes. At each of the locations of the first electrodes and second electrodes arranged one above the other, the spacer membrane has a continuous recess, such that each of the first electrodes is arranged in partially overlapping manner with one of the continuous recesses and one of the second electrodes in a direction perpendicular to the carrier membranes and in each case forms an active switching element 461, 462, 463. When a threshold value for a force G acting in the direction 40 perpendicular to the mounting plate 30 on one of the active switching elements 461, 462, 463 is exceeded, a switching state of the switching element 461, 462, 463 in question is modifiable by the first electrode and the second electrode of the active switching element 461, 462, 463 in question forming an electrical contact.

Viewed in the seating direction, the membrane switch 44 of the seat occupancy sensor unit 28 is arranged between the H point and a front edge of seat 10 or directly in front of the H point. The H point is the point of the theoretical axis of rotation between the leg and the torso of a human body represented by a manikin, in a vertical, longitudinal plane of the seat 10.

The seat occupancy sensor unit 28 furthermore comprises a release membrane element 48 formed by a rectangular membrane of polytetrafluoroethylene (PTFE) with a thickness of 1.0 mm which, in the operational state, is arranged above the membrane switch 44 and parallel to the mounting plate 30 and separates the membrane switch 44 from the foam element 14, whereby the membrane switch 44 can be effectively prevented from adhering to the foam element 14.

The recess 20 on the B side of the foam element 14 takes the form of a first step 22 and a second step 24 of a rectangular pyramid with two steps. The first step 22 is here intended to accommodate a peripheral zone 36 of the mounting plate 30 and, in the operational state, is in contact with the peripheral zone 36 of the mounting plate 30. The height of the first step 22 corresponds to a thickness of the mounting plate 30, such that the bottom 32 of the mounting plate 30 and the B side of the foam element 14 form a common plane. The second step 24 serves to accommodate the remaining parts of the seat occupancy sensor unit 28. In an unoccupied state of the seat 10, a dimension 26 of the recess 20 in the direction 40 perpendicular to the mounting plate 30 and measured from the latter is greater than a dimension of the seat occupancy sensor unit 28 in said direction 40.

Two mutually facing first securing elements 50 which are formed by plastics mounts conventional in vehicle engineering and are separated by the support element 38 are provided in the peripheral zone 36 of the mounting plate 30. On the B side of the foam element 14 are arranged corresponding second securing elements 52 in the form of plastics clips which are adhesively bonded to the foam element 14. The seat occupancy sensor unit 28 is installed by bringing the first securing elements 50 into mutual engagement with the corresponding second securing elements 52, so forming a firm, undoable connection between the seat occupancy sensor unit 28 and the foam element 14.

FIG. 2 shows the vehicle seat according to an embodiment of the invention in the view according to FIG. 1 in an occupied state. The weight force G exerted by the seated person is transferred by the foam element 14 in the direction 40 perpendicular to the mounting plate 30 to the membrane switch 44 of the seat occupancy sensor unit 28. FIG. 2 shows a state in which the threshold value for the force acting in the direction 40 perpendicular to the mounting plate 30 on the switching elements 461, 462, 463 has been exceeded, such that the switching states thereof are modified from “contact open” to “contact closed”. For reasons of clarity, the bottom 18 of the foam element 14 is not shown in the mechanical contact with the release membrane element 48 prevailing in this situation.

In the operating state shown in FIG. 2, the membrane switch 44 is completely in contact with the support element 38 at the locations of the active switching elements 461, 462, 463. A change in the dimension of the support element 38 in the direction perpendicular to the active switching elements 461, 462, 463 amounts less than 1% of a change in the dimension of the membrane switch 44 in the same direction.

FIG. 4 schematically illustrates the ratios of forces on the membrane switch 44 of the seat occupancy sensor unit 28 in the occupied state of the seat 10 shown in FIG. 2.

In the situation indicated (a), a force FG acts in the direction 40 perpendicular to the mounting plate 30. Said force FG can be vectorially broken down into a force component Ft, which acts tangentially to the carrier membranes of the membrane switch 44, and a force component Fn, which acts perpendicularly onto the membrane switch 44. The tangentially acting force component Ft is compensated by the strength of the carrier membranes. The perpendicularly acting force component Fn brings about a modification in the switching states of the active switching elements 461, 462, 463 when the threshold value is exceeded.

In the situation indicated (b), a force FG′ acts, at variance from the perpendicular direction 40, towards the middle of the seat 10. When said force FG′ is broken down vectorially, the tangentially acting force component Ft′ proves to be smaller than in the case of the perpendicularly acting force FG, while the force component Fn′ acting perpendicularly onto the membrane switch 44 is greater, so ensuring increased sensitivity of the membrane switch 44 to forces acting obliquely onto the seat cushion of the seat 10.

As is apparent from FIG. 2, the foam element 14, the release membrane element 48 and the membrane switch 44 are deformed by the exerted weight force G. These deformations are reversible, such that foam element 14, release membrane element 48 and membrane switch 44 return to their prior dimensions and positions on discontinuation of the weight force G. The release membrane element 48 here prevents the foam element 14 from adhering to the membrane switch 44.

1. A seat occupancy sensor unit for recognising occupancy of a seat, in particular of a vehicle seat, comprising:
a mounting plate with a bottom and a top, the bottom facing, in an operational state, a floor on which the seat is fitted, and the top facing a seat cushion of the seat,
a membrane switch which responds to pressure having at least one active switching element, the switching state of which is modifiable when a threshold value for a force acting in a direction perpendicular to the at least one active switching element is exceeded,
at least one support element which is arranged between the top of the mounting plate and the membrane switch,
wherein the at least one support element has a developable, convexly curved surface, the dimensions of which are greater than or equal to the dimensions, measured in the same direction, of the membrane switch, and which is provided for the purpose, in at least one operating state, of coming into at least partial contact with the membrane switch at least at the location of the least one active switching element.

2. A seat occupancy sensor unit according to claim 1, wherein the membrane switch which responds to pressure comprises at least one first flexible, electrically insulating carrier membrane and one second flexible, electrically insulating carrier membrane and at least one first electrically conductive electrode and one second electrically conductive electrode,
wherein the first flexible, electrically insulating carrier membrane and the second flexible, electrically insulating carrier membrane are arranged spaced apart from one another substantially parallel to one another and are separated from one another by an electrically insulating spacer membrane and, in an unoccupied state of the seat, the spaced carrier membranes are arranged substantially parallel to the mounting plate, wherein the first electrically conductive electrode is arranged on the first carrier membrane and the second electrically conductive electrode is arranged on the second carrier membrane, and
wherein the spacer membrane comprises at least one continuous recess, and the first electrically conductive electrode, the second electrically conductive electrode and the continuous recesses are arranged in at least partially overlapping manner in a direction perpendicular to the carrier membranes to form the at least one active switching element.

3. A seat occupancy sensor unit according to claim 1, wherein a change in a dimension of the support element in the direction perpendicular to the at least one active switching element amounts to less than 10% of a change in the dimension of the membrane switch in the same direction on exposure to a force corresponding to the threshold value.

4. A seat occupancy sensor unit according to claim 1, wherein the convexly curved surface of the support element takes the form of part of a circumferential surface of a right cylinder with an elliptical base area.

5. A seat occupancy sensor unit according to claim 1, wherein an aspect ratio of the convexly curved surface of the support element amounts to at least 3:1.

6. A seat occupancy sensor unit according to claim 1, wherein the convexly curved surface of the support element takes the form of part of a circumferential surface of a right cylinder with a circular base area, the diameter of which amounts to between 20 mm and 100 mm and the support element has a height measured from the top of the mounting plate of up to 10 mm.

7. A seat occupancy sensor unit according to claim 1, wherein the support element and the mounting plate are of one-piece construction.

8. A seat occupancy sensor unit according to claim 1, wherein the membrane switch comprises a plurality of active switching elements which are spaced apart from one another and, in an operational state, are arranged in a seating direction of the seat.

9. A seat occupancy sensor unit according to claim 1, further comprising a release membrane element which, in the operational state, is arranged above the membrane switch.

10. A seat occupancy sensor unit according to claim 1, wherein the first electrode and the second electrode are produced by thick-film technology.

11. A seat occupancy sensor unit according to claim 1, wherein at least one of the flexible, electrically insulating carrier membranes at least predominantly consists of a thermoplastic.

12. A seat, in particular a vehicle seat, comprising:
a seat base for supporting a person in a sitting position,
a seat cushion with at least one foam element for padding the seat base, the at least one foam element having a top facing a person in the sitting position and a bottom facing the seat base, and
a seat occupancy sensor unit according to claim 1, wherein the at least one foam element contains on the bottom thereof a recess for accommodating the seat occupancy sensor unit.

13. A seat according to claim 12, wherein, in the direction perpendicular to the mounting plate, the recess takes form of a first step and a second step, and wherein the first step is provided for accommodating a peripheral zone of the mounting plate and the second step serves to accommodate the remaining parts of the seat occupancy sensor unit, wherein, in the direction perpendicular to the mounting plate, a dimension of the recess in an unoccupied state of the seat is greater than a dimension of the seat occupancy sensor unit in said direction.

14. A seat according to claim 12, wherein, viewed in the seating direction, the membrane switch of the seat occupancy sensor unit is arranged between an H point of the seat and a front edge of the seat or directly in front of the H point.

15. A seat according to claim 12, wherein the seat occupancy sensor unit has at least one first fastening element and the foam element has at least one second fastening element arranged on the bottom thereof, and wherein the first fastening element and the second fastening element can be brought into mutual engagement to produce a firm, undoable connection.
